(19) United States
(12) Patent Application Publication
(10) Pub. No.: US 2009/0021367 A1
(43) Pub. Date: Jan. 22, 2009

(54) APPARATUS, SYSTEM, AND METHOD FOR TRACKING ANIMALS

(76) Inventor: DANIEL F. DAVIES, FILLMORE, UT (US)

Correspondence Address: ADVANTIA LAW GROUP, 9035 SOUTH 1300 EAST, SUITE 200, SANDY, UT, 84094, US

(21) Appl. No.: 11/780,198

(22) Filed: Jul. 19, 2007

(51) Int. Cl. G08B 1/08

(52) U.S. Cl. 340/539.1

(57) ABSTRACT

An apparatus, system, and method for tracking animals. The present invention comprises: a card, having: mailing information and a tracking module, including: a storing module that stores location information; instructions; a display module that displays location information; an activation module that activates the tracking module; a reception module that receives location information; a data collection module that collects location data; a transmission module that transmits location information and data; and a reset module that resets location information; a card labeling module that labels a card. The invention comprises the steps of: providing a card having a tracking module; associating the card with a recipient; mailing the card to the recipient; enabling the recipient to activate the tracking module; acquiring location information upon activation of the tracking module; storing the location information; and enabling the recipient to mail, return, and forward the card.

### BACKGROUND OF THE INVENTION

1. Field of the Invention

The present invention relates to tracking systems and methods, specifically an apparatus, system, and method for tracking the location of animals.

2. Description of the Related Art

Examples of valuable objects that are easily lost include television remote controls, portable telephones, checkbooks, purses, etc. Searching for lost or misplaced objects is often a very time-consuming task, particularly for business organizations. For example, in the retail management arena, the tracking of items, such as clothing or stock parts for manufacturing purposes often requires extensive inventory-taking on a daily basis. If an inventory item can not be located then a sale may be lost or a manufacturing order may go unfilled. Moreover, the business manager may order items, not knowing whether or not a supply item exists on the premises or in some unidentified location. Since the beginning of history, people have sought to solve this problem in many ways by devising methods to help keep track of useful objects.

A popular communications system employed to monitor the movements of people and objects is the global positioning system (GPS). It is appreciated in the art of communications systems that the GPS comprises a network of satellites orbiting in outer space above the Earth's surface, ground stations, and GPS receivers that communicate with each other through continuous and real-time transmission/reception of electrical signals in the network. The GPS network assists users with locating people and objects globally.

Individuals typically employ a GPS apparatus or system as a means of identifying the location of a plurality of missing or lost items. For example, the Department of Agriculture has encouraged State agencies to develop a complete registry of the location of its domestic animals. In particular, the Department of Agriculture has encouraged States to register animals which are part of the food chain or which could have an effect on the spread of disease in the food chain. Under current registration programs, State agencies have begun to register the location of cattle, with the registration of other animals, such as but not limited to horses and sheep.

Currently, state governments often pay private companies to register these locations. Location registration is often accomplished by company employees driving to private livestock locations and using a hand-held GPS receiver to register the location. The location is then compared against the GPS location estimated by a computerized, mapping system software installed in the receiver.

The state government generally pays for each location registered. However, the cost of driving to each location keeps the returns for private companies low. Further, there is often substantial wear and tear on equipment, and wasted time because of the rural nature of the locations. Accordingly, there exists a need for an easily mailed GPS receiver, such as an electronic card, which would replace the need for private company employees to drive to each location, and which would easily and efficiently track animal locations.

Some improvements have been made in the field. Examples include but are not limited to the references described below, which references are incorporated by reference herein:

U.S. Patent Application Publication No.: 2003/0137449 by Vashisth et al., discloses a system for capturing a virtual model of a site includes a range scanner for scanning the site to generate range data indicating distances from the range scanner to real-world objects. The system also includes a global positioning system (GPS) receiver coupled to the range scanner for acquiring GPS data for the range scanner at a scanning location. In addition, the system includes a communication interface for outputting a virtual model comprising the range data and the GPS data.

U.S. Pat. No. 6,674,368 issued to Hawkins et al., discloses a method and apparatus for tracking the location of assets and persons are provided. According to the invention, position information is provided to a central monitoring station aperiodically. The central monitoring station utilizes software agents to analyze the information received from remote tags, and to determine the appropriate action to take with respect to that information. In particular, the central monitoring station provides aperiodic notifications to authorized users regarding the position and status of a monitored person or asset. The central monitoring station operates without requiring human analysis of the information received from remote tags. Furthermore, the use of aperiodic transmissions of information to the central monitoring station, and the use of software agents in the central monitoring station, allows the present invention to efficiently process information received from a large number of remote units.

U.S. Pat. No. 7,065,446, issued to Chou, discloses a smart location information processor automatically detects the location of a moving object in real-time, using either a receiver from the satellites or from any terrestrial location detection network. The device processes the location information and activates responsive functions according to location and status. Messages are transmitted through one of multiple wireless communication networks to other units. At any time, the device may receive instructions wirelessly from other stationary or mobile objects. All the events of the installed moving object are stored in a history file which can be sent to a remote server and then cleared from the installed object, either regularly or instantaneously. The device in one object may automatically activate certain functions controlling the object in response to the location of another object installed with the same device.

U.S. Patent Application Publication No.: 2005/0024201, by Culpepper et al., discloses the present invention is directed to a method of asset location. The method includes the step of linking at least one portable transmitter system with a selected asset. A cellular communication is then initiated from the at least one portable transmission system to an associated device controller. Primary location information representing the cellular area from which the cellular communication is made is then communicated to the device controller. A secondary location system is then initiated in accordance with the location information. The secondary location information, from the portable transmission system, is then broadcast and received into a tracking system. The method of asset location includes the steps of simultaneously monitoring a plurality of portable transmission system communications, and generating fee data representing each of a plurality of monitored portable data transmissions. The primary and secondary location information are then transmitted to a law enforcement authority in order to track the asset that is determined to be stolen.

U.S. Pat. No. 6,972,698, issued to Deguchi, discloses a method and system for a satellite network data communication enabled electronic bookmarking device for bookmarking positional information of a desired location or locations in addition to bookmarking broadcast music clips over registered radio or television stations is provided.

The inventions heretofore known suffer from a number of disadvantages, which include: not being portable, being difficult to use, being expensive, being inefficient, being difficult to transport; and/or being otherwise impractical for registering animals.

What is needed is a tracking system and method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available tracking systems and methods. Accordingly, the present invention has been developed to provide an apparatus, system, and method for tracking animals.

There is one embodiment of the present invention that includes a method for tracking animals, comprising the steps of: providing a card, that may include a tracking module; and/or associating the card with a recipient; and/or mailing the card to the recipient; and/or enabling the recipient to activate the tracking module; and/or acquiring location information upon activation of the tracking module; and/or storing the location information; and/or enabling the recipient to mail the card; and/or enabling the recipient to return the card; and/or enabling the recipient to forward the card.

In addition to the method, one embodiment of the invention includes an apparatus, having: a card, that may include: mailing information, disposed on the card; and/or a tracking module that may be removably coupled to the card, and comprising: an activation module; and/or an information reception module. According to one embodiment, it may be that the card includes: a transmission module, in communication with the tracking module, and/or configured to transmit location information from the tracking module; and/or an information storing module, in communication with the tracking module, and/or configured to store location information; and/or instructions.

In another embodiment of the invention, it may be that the tracking module further comprises a display module. In yet another embodiment of the invention, there may be a card further comprising an information reset module, in communication with the information storing module, configured to reset location information. In still yet another embodiment of the invention, there is a card labeling module that may be configured to label a card with mailing information; and/or a card, in communication with the card labeling module that may include mailing information.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a top plan view of an exemplary location on a map according to one embodiment of the invention;

FIG. 2 is a flowchart diagram of a method of tracking the location of animals according to one embodiment of the invention;

FIG. 3 is a flowchart diagram of a method of tracking the location animals according to one embodiment of the invention;

FIG. 4 is a block diagram depicting a modular view of an apparatus for tracking the location of animals according to one embodiment of the invention;

FIG. 5 is a front elevational view of an apparatus for tracking the location of animals according to one embodiment of the invention;

FIG. 6 is a rear elevational view of an apparatus for tracking the location of animals according to one embodiment of the invention;

FIG. 7 is a block diagram depicting a modular view of a system for tracking animals according to one embodiment of the invention;

FIG. 8 is a front elevational view of an apparatus for tracking the location of animals according to one embodiment of the invention;

FIG. 9 is a rear elevational view of an apparatus for tracking the location of animals according to one embodiment of the invention;

FIG. 10 is a block diagram depicting a modular view of a system for tracking animals according to one embodiment of the invention; and

FIG. 11 is a schematic diagram of a location registration card according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: show data, participant data; sponsor data; financial institution data; and/or like data useful in the operation of the present invention. As those skilled in the art will appreciate, any computers discussed herein may include an operating system (e.g., Windows NT, 95/98/2000, OS2, UNIX, Linux, Solaris, MacOS, etc.) as well as various conventional support software and drivers typically associated with computers. The computers may be in a home or business environment with access to a network. In an exemplary embodiment, access is through the Internet through a commercially-available web-browser software package.

As set forth in the specification, the system and method of the invention may facilitate the providing information to participants through multiple media sources and may allow the player modules to receive information via similar multiple media sources. The multiple media sources may include, for example, chat room, radio, bulletin board, internet web pages, email, billboards, newsletters, commercials and/or the like. The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

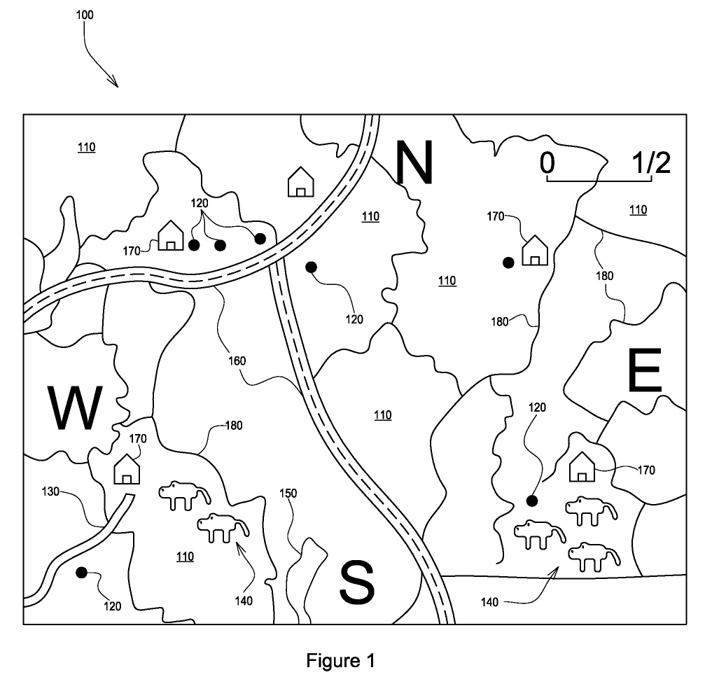

FIG. 1 is a top plan view of an exemplary location 110 on a map 100 according to one embodiment of the invention. As shown, there is a plurality of rural locations or areas 110 on the map 100 having: a plurality of location points 120; a newly paved roadway or street 130 that is not designated or otherwise marked on available maps, atlases, etc. on sale in the retail marketplace; a plurality of domestic livestock 140 such as cattle, horses, pigs, sheep, dogs, cats, etc. owned by individuals; an abandoned or dilapidated roadway 150 that may have been washed out due to heavy torrential precipitation from storms, in close proximity of environmental hazards from radon, excessive chemical spills, etc., otherwise looks differently than as seen on a map or atlas; a plurality of major roadways 160 such as a interstate/intrastate highway, main street, etc.; a plurality of structures 170 including but not limited to residential houses, company warehouses, barns, or any other building where people and/or livestock 140 (also referred to as animals) may typical reside therein; a political boundary 180 separating townships, counties, cities, states, countries, etc. such as typically shown on political maps 100 available for sale in the retail marketplace.

In operation of one embodiment of the invention, a business organization or entity desiring a specific location of an object of interest, such as livestock 140, requiring registration with the federal, state, or city government may contact local residents at a given rural location 110 and mail them an apparatus, such as an electronic location registration card. The business organization (also referred as a card distributing entity) may then request the residents (also referred to as a card recipients) to travel to a location point 120 in close proximity to the object of interest. According to one embodiment, the location point 120 includes the following non-limiting examples of location information that may be traceable by a GPS receiver: latitude and longitude lines (e.g., 27°13′27″N 152°13′27″E) generally labeled on a geographical map; grid coordinates (e.g., 14178484) generally labeled on a grid reference map such as one skilled in the art would understand may be employed by government and military organizations when conducting land navigation and search/rescue missions to locate lost personnel/equipment for example, major accident sites, etc.; mailing addresses; etc. Once the card recipient(s) arrive to the location point 120, they may count the number of livestock 140 for example; push a button and the card may then record and store the location information therein. In one embodiment, the card recipient may also write information on the card, such as the number of cows. The card recipients may then send the card back to the card distributing entity. After receiving the card from the card recipients, the business organization may download the local information from card to computer database at the company or business location such that the livestock 140 may be registered, as required.

Advantageously, employing the present inventive apparatus, system, and method would alleviate the card distributing entity from dispatching its employees to geographically separated locations 110 in order to obtain the location information regarding the object(s) of interest. For example, a card distributing entity such as the U.S. Department of Agriculture may send location registration cards to the card recipients in various rural areas 110 where card recipients may own domestic livestock 140 such as cattle for example. U.S. Department of Agriculture may then request the card recipients or livestock owners to push a button on the card at a location 110, location point 120 or structure 170 where livestock resides. In addition, there may be instructions on the card requesting livestock owners to send the card with the location information back to the U.S. Department of Agriculture. This would significantly reduce U.S. Department of Agriculture's travel/fuel cost and wear/tear on its government vehicles and other assets associated with traveling to remote locations 110 to perform their jobs.

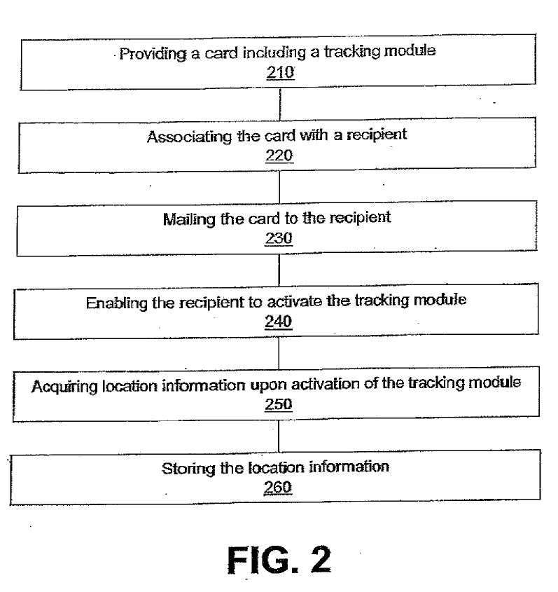

FIG. 2 is a flowchart diagram of a method of tracking the location of animals 140 according to one embodiment of the invention. According to the illustrated method, the card distributing entity provides 210 a location registration card to the card recipients in any given rural or undeveloped location(s) 110 that may be shown on the map 100 by means of manufacturing/distributing the card thereto. The card distributing entity then associates 220 the card with a card recipient by imprinting the card recipient's mailing address on the card. Next, the entity mails 230 the card to the card recipient, through a mail distributing service agency (e.g., Post Office, United Parcel Service, Inc., Federal Express, Inc.). Then, the entity enables 240 the recipient to activate a tracking module, such as a GPS receiver coupled to the card. One skilled in the art would appreciate that a GPS receiver is in microwave communications with a network of GPS satellites, thereby enabling the tracking module to be employed to track the location of people and objects anywhere in the world. The card recipient then acquires 250 location information, such as, but not limited to: latitude/longitude of a location point 120 in close proximity to livestock 140, the number of livestock, location of new roads, abandoned roads, etc. In one embodiment, the card distributing entity may acquire such location information upon receipt of a card containing the location information from the card recipient. The card distributing entity then stores 260 the location information into their local computer database. For example, the location information may be stored by inserting the card into their computer terminal and manipulating the required software to download the desired location information from the card to the computer database.

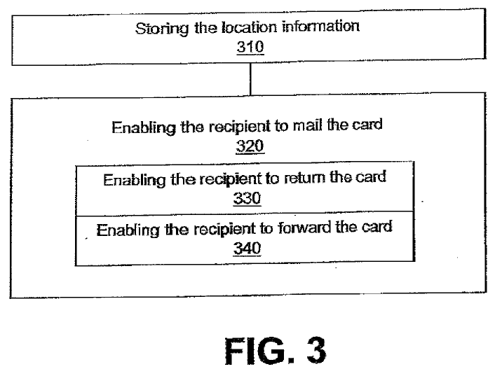

FIG. 3 is a flowchart diagram of a continuation of the present inventive method shown in FIG. 2 according to one embodiment of the invention. As illustrated, after storing 310 the desired location information into the card, the card distributing entity performs the following steps: enable 320 the card recipient to mail the card back to the entity's location by providing the card recipient some form of mailing instructions on the card and providing the card recipients with a mailing envelope; enable 330 the card recipient to return the card by labeling the card with a return mailing address and/or providing the recipient with a return address on an envelope; and enable 340 the card recipient to forward the card to a second card recipient in a second rural area 110 by including one or more additional stamped envelopes and instructions instructing the second card recipient to forward the card to a third card recipient, and so forth, so that additional location information may be obtained from a given area 110 on the map 100.

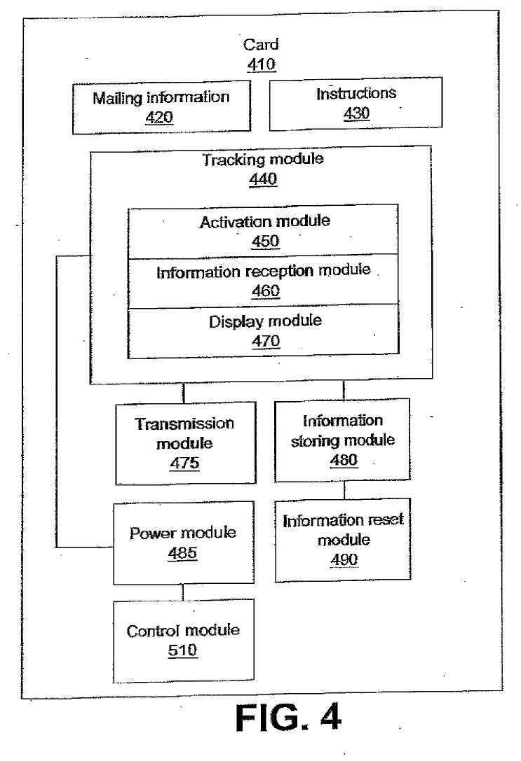

FIG. 4 is a block diagram depicting a modular view of an apparatus 400 for tracking the location of animals according to one embodiment of the invention. As shown, the apparatus is a location registration card 410, such as a 3030A011 Location Registration Card manufactured by Excalibur Engineering Services, Inc., 962 East 2100 North, North Logan, Utah 84341. As shown, the card includes: mailing information 420, such as, but not limited to a building number/street address, state, postal code, etc. of the card recipients in a rural area 110 so that the card distributing entity may associate the card with a particular card recipient prior to mailing the card to said card recipient; a plurality of instructions 430 that teaches card recipient(s) how to operate the card and employ it to collect and save location information therein.

In one exemplary embodiment, the location registration card 410 further includes a tracking module 440. Some non-limiting exemplary examples of a tracking module is an AllwinQ GR-353-m GPS Smart Antenna and Receiver, a AllwinQ SGM-031 GPS Smart Antenna and Receiver, and a GPS-901 GPS Smart Antenna and Receiver, wherein each are distributed by AllwinQ Ltd., 11F.-1, No. 59, Jianzhong Road, Hsinchu City 300, Taiwan. In one embodiment, the non-limiting examples of the tracking module supports computer connectors (e.g., USB, PS2) such that the tracking module may be electrically coupled to and operated with handheld PCs, electronic notebooks, pocket PCs, Palm Pilots, PDAs, etc. One skilled in the art would understand that the GPS receiver is an integrated semiconductor circuit or chip that is operably configured to receive location information in the form of electrical signals from GPS satellites, such that the tracking module 440 may monitor the location of objects.

More, the illustrated tracking module 440 includes an activation module 450 comprising a push button switch, such as one manufactured by Honeywell Sensing and Controls, Inc., 11 West Spring Street, Freeport, Ill. 61032 for example, wherein the activation module 450 is configured to activate the card 410 in a mode to collect location information. Additionally, the illustrated tracking module includes an information reception module 460 as described in WO Patent 2006038524, issued to Nagase Ayako, which teachings are incorporated by reference herein for its supportive teachings. The information reception module 460 may also comprise a receiving antenna coupled to the tracking module 440 and configured to receive electrical signals from GPS satellites orbiting overhead of a given location 110 on the map 100 upon activation of the card 410 by the activation module 450 (also referred to as an activation module button). More, the tracking module 440 includes a display module 470, such as a light crystal display (LCD) screen and a graphical user interface (GUI) enabling a card recipient and a card distributing entity to view and/or manipulate location information that may be displayed therefrom.

According to one embodiment, the location registration card 410 includes a transmission module 475, such as a transmitting antenna. The transmission module is configured to transmit electrical signals, in the form of location information, received from GPS satellites by the tracking module 440 and the information reception module 460 to the information storing module 480 (e.g., read-only-memory (ROM) circuit/card) when the card recipient manipulates the activation module 450. The information storing module is configured to store and save the location information into the card 410 for later retrieval by a user regardless if the card 410 is activated or deactivated. Additionally, there is an illustrated information reset module 490, such as a push button switch, in electrical communication with the information storage module 480, and configured enable an end user at a card distributing entity facility to selectably delete or erase location information from the information storing module 480 when the push button switch is pressed. Further, there is a power module 485, such as a light-weight NEWSUN CR1632 Primary Dry Button-Cell Battery manufactured by Shun Wo New Power Electronics (Shenzhen) Co Ltd, 17-19 Prat Avenue, Tsimshatsui, Kowloon, Hong Kong SAR, China, in electrical communication with the tracking module 440 and configured to provide direct current (DC) electrical power to the card 410 required for a card recipient to employ the card to collect location information pertaining to animals 140. Some other non-limiting examples of a dry cell battery includes: a lithium cell battery, an alkaline battery, a zinc-carbon battery, etc.

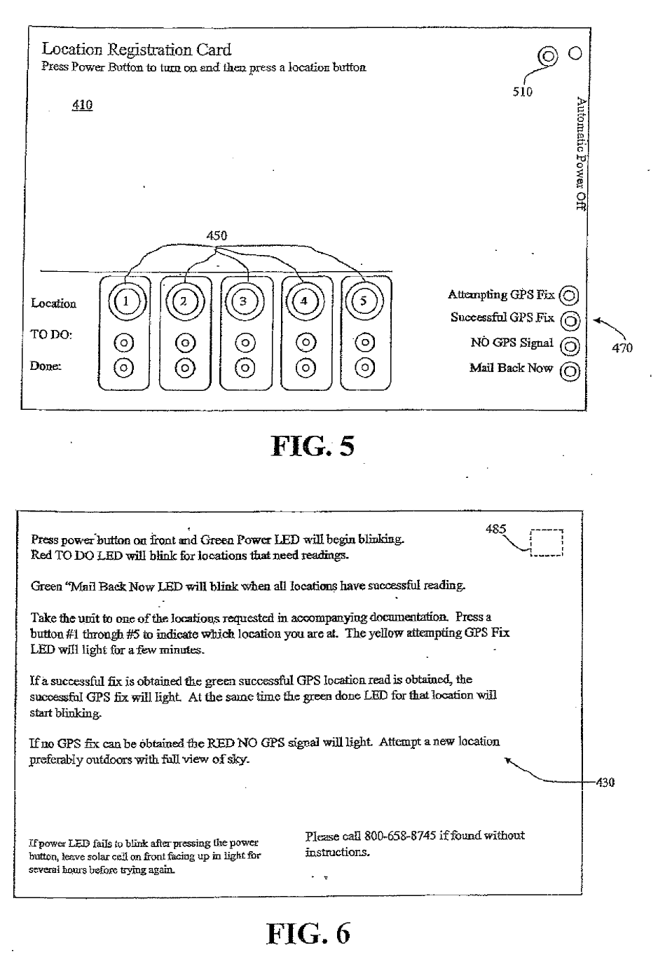

FIG. 5 is a front elevational view of an apparatus 400 for tracking the location of animals 140 according to one embodiment of the invention. There is an illustrated control module 510 in electrical communication with an activation module 450, wherein the modules 450, 510 are collectively indicated by a plurality of push button switches. The control module is configured to control the distribution of DC electrical power to the activation module when pressed by a user. According to one embodiment, a user may press one to five buttons corresponding from one to five locations 110 on the map 100, thereby to initiating signal communication with the card 410 with other GPS devices in a GPS network, such that location information pertaining to the animals may be captured and stored into the card from one to five locations.

Advantageously, distributing card(s) 410 with a plurality of activation module buttons 450 disposed thereon precludes the card distributing company from either increasing motor vehicle fuel consumption and/or wear and tear associated with dispatching its employees to geographically separate locations 110 to gather the desired location information needed to register the animals 140. Further, employing multiple activation module buttons significantly reduces the cost of manufacturing card(s) 410 associated with a requirement of manufacturing one card for one use at one corresponding location 110.

In operation of one embodiment of the invention, the card distributing entity distributes a card 410 to a card recipient who owns a plurality of animals dispersed over a plurality of locations 110. The card distributing entity then requests the card recipient to travel to a first location 110 or structure 170 where animals 140 are located. The card recipient then manipulates the control module 510 to activate the card 410 and presses a first activation module button 450 to capture location information pertaining to animals, such as cattle, for example. The card recipient then travels to a second location 110 where animals 140 are located and presses a second activation module button 450 to capture additional location information, such as horses, for example. The card recipient repeats this process until location information is gathered for a specified number of locations 110.

FIG. 6 is a rear elevational view of a card 410 according to one embodiment of the present invention. As shown, there is plurality of instructions 430 listed on the card that is adapted to guide the card recipient through a process of operating the card to obtain location information. In operation, the instructions 430 may instruct the card recipient to manipulate the control module 510 such that either green lights (indicating location information has been gathered from the location) or red lights will blink (indicating locations needing location information gathered therefrom).

In operation of one embodiment of the invention, once the location information has been successfully gathered from relevant locations 110 green lights flash on the display module 470. The instructions 430 then instructs the card recipient to take a card 410 a location 110, and press an activation module button 450 corresponding to the location 110 where he or she has the card. Then, the display module 470 displays a yellow light for a period of time indicating that the tracking module 440 is attempting to communicate with GPS receivers, satellites, etc. to obtain a fix on the given location. When a successful fix occurs and location information is gathered, the card recipient simultaneously views a green light and a blinking green light from the display module, indicating fix is completed. Conversely, when a GPS fix is unsuccessful, the instructions 430 tell the card recipient that the tracking module 440 could not communicate with GPS receiver(s). In this case, the card is instructed to attempt the same process at a second location 110.

According to one embodiment, if the power light fails to blink from the control module 510, the instructions 430 may instruct the card recipient to leave a solar cell or module on front facing up for several hours so the power module 485 may be charged by solar energy from the sun prior to trying to activate the card 410 again. In one embodiment, there may be a recharge module that may connect to an electrical system to receive power and charge/recharge the power module. As a non-limiting example, such connection may be through a serial port to a computer. Further, the instructions may request that the card recipient contact the card distributing entity for instructions 430.

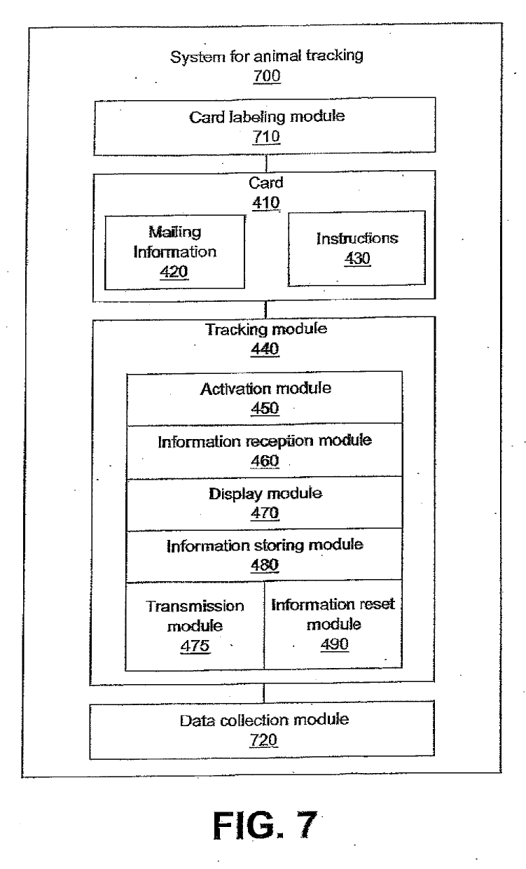

FIG. 7 is a block diagram depicting a system 700 for tracking animals according to one embodiment of the invention. As shown, there is card labeling module 710, such as a Labeling System software produced by PRISYMID Inc., 10801 Johnston Road, Suite 230, Charlotte, N.C. 28226, configured to enable the card distributing entity to print out sticky labels with text/graphics disposed thereon, and manually couple the labels to the card 410. Some non-limiting examples of text/graphics may include: card distributing entity and/or card recipient information, an address, a state, a postal code, a telephone or a fax number.

Additionally, the card 410 is configured to be in electromechanical communication with a data collection module 720 comprising a computer hardware, software, and operating system with GPS capabilities and sufficient capacity to process and store relatively large amounts of location information. For instance, one non-limiting example of the data collection module is an IBM System Z manufactured by IBM Corporation, 1 New Orchard Road, Armonk, N.Y. 10504. Accordingly, the data collection module may be located at the card distributing company and adapted to be controlled by end users at the card distributing company. The end users may also download desired location information from the information storing module 480 of the card 410 onto an animal registry database, such an Oracle Database manufactured by Oracle Corporation, 500 Oracle Parkway, Redwood Shores, Calif. 94065, disposed in the data collection module 720 such that the animal locations 110 may be registered.

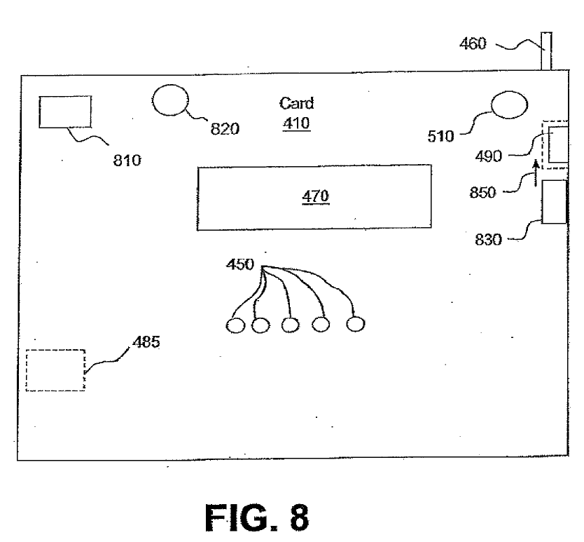

FIG. 8 is a front elevational view of an apparatus 400 or card 410 for tracking the location of animals according to one embodiment of the invention. As shown, the card 410 may include a power module 485, such as a dry cell battery that may be rechargeable by solar energy from the sun emitted into a solar module 810, such as is described in U.S. Pat. No. 4,634,953 issued to Shoji et al., and a camera module 820, such as described in U.S. Patent Application Publication 2004/0198313 by Chiu, which is incorporated by reference herein. In one embodiment, the camera module 820 is configured for a user to capture digital photographs of animals 140 or other objects at desired location 100, in a wireless communications network, upon pressing the activation module buttons 450.

Additionally, one embodiment of the card 410 may include first securing mechanism 830, such as a spring actuated cover or the like, in slidable mechanical communication with the information reset module 490. In another embodiment, the first securing mechanism 830 may be linearly adapted to slide over and cover the information reset module 490, as indicated by arrow 850, thereby preventing the card recipient from inadvertently deleting location information stored by the information storing module 480 prior to the card 410 being returned to the card distributing entity per the instructions 430.

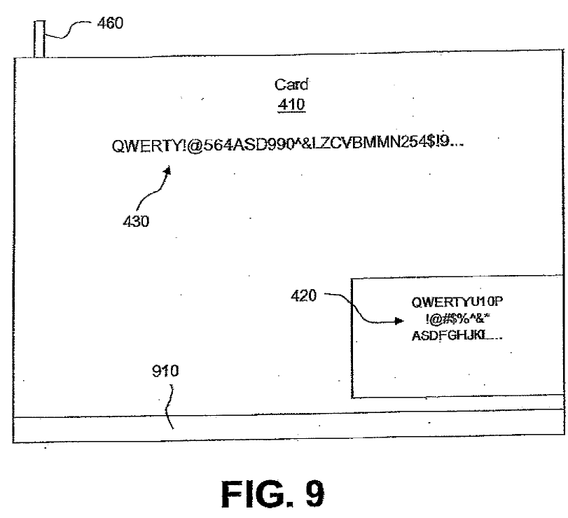

FIG. 9 is a rear elevational view of an apparatus 400 for tracking the location of animals according to one embodiment of the invention. As shown, the mailing information 420 may comprise the physical address, postal code, phone number, etc. of the card recipient that is listed in the data collection module 720, thereby enabling the card to be found in cases where it becomes lost or misplaced at a location 110. Further, according to one embodiment, the card 410 may include a magnetic reader strip 910, and may be comprised of ferromagnetic material as described in U.S. Pat. No. 5,627,663 issued to Horan et al., which is incorporated by reference herein. In another embodiment, the magnetic readers strip is coupled to the rear of card and configured for the card to be inserted into a magnetic reader, wherein said magnetic reader may be coupled to a computer database at the card distributing entity facility for the downloading of location information from the card thereto.

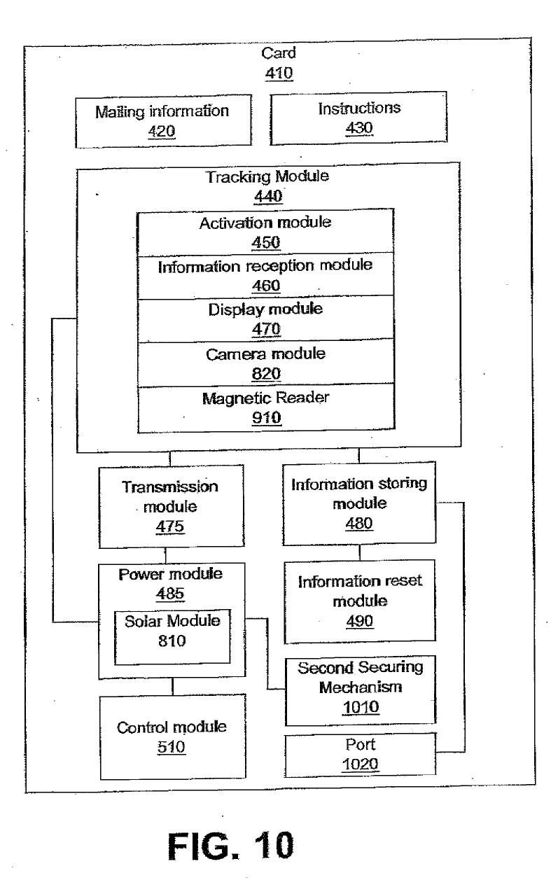

According to an embodiment as shown in FIG. 10, the card 410 may include a second securing mechanism 1010, such as a time-invariant electrical circuit in the form of a switch that may be integrated into the circuitry of the card 410. The second securing mechanism 1010 is adapted to be in electrical communication with the control module 510 and configured to automatically halt the flow of current through the circuit, thereby deactivating the card 410 after a predetermined period of inactivity. As a result, the life of the power module 485 may be preserved or otherwise extended. Additionally, there may be a USB port 1020 coupled to the card and adapted for the card to be removably coupleable to a mobile communications device (e.g., cellular phone, PDA, smartphone, etc.) via a USB cable or the like, such that a card recipient may employ the mobile communications device to contact the card distributing entity. This feature enables the card recipient to conveniently relay animal location information from the card to the card distributing entity, particularly during instances where the location information is needed promptly. For example, a case may arise where the location information is needed to meet an animal registration deadline.

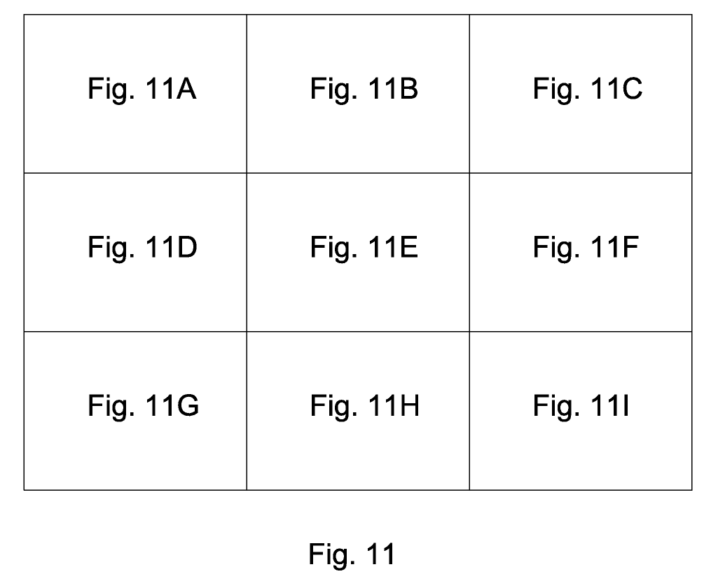

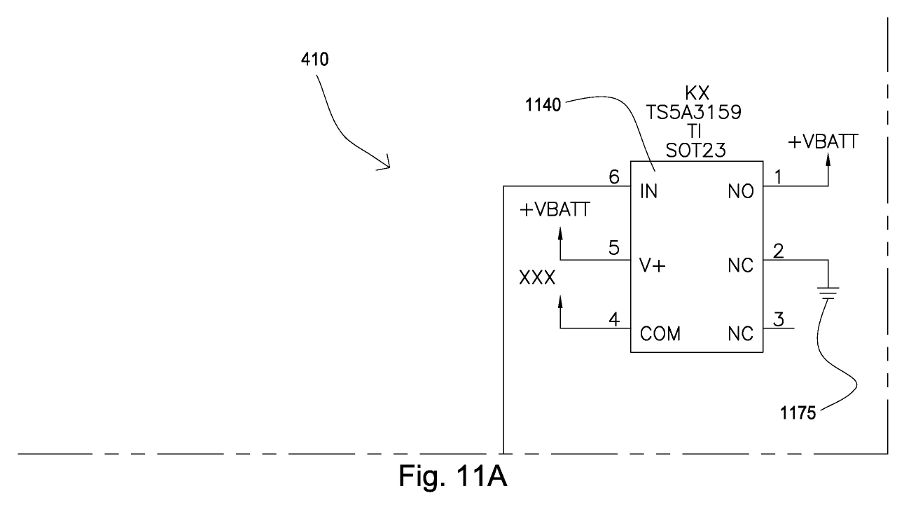

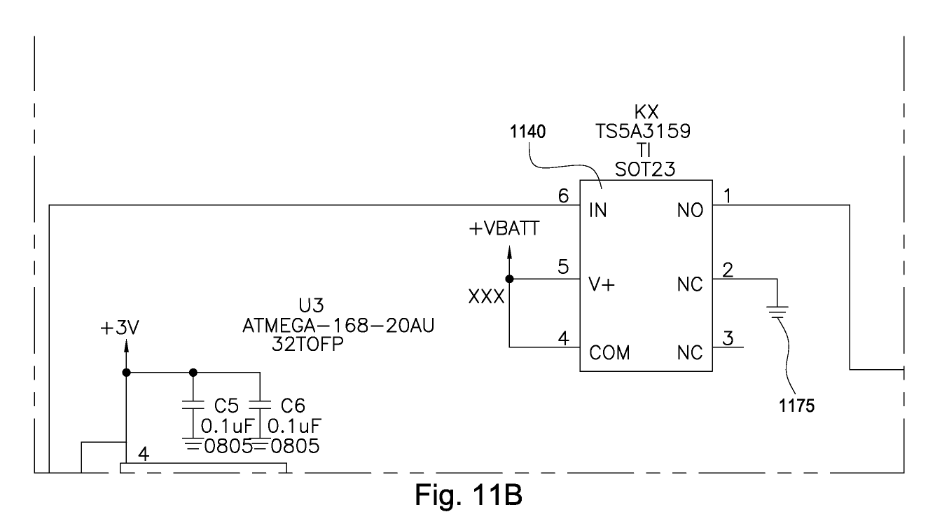

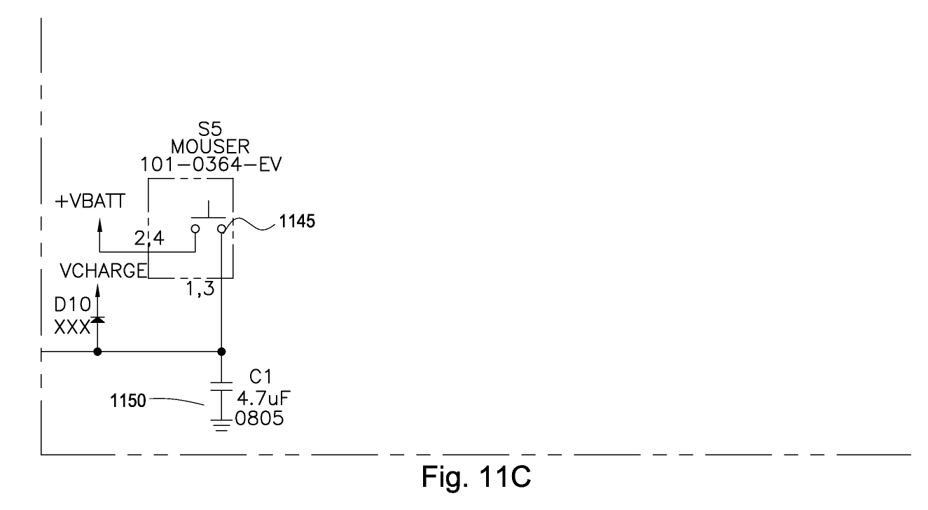

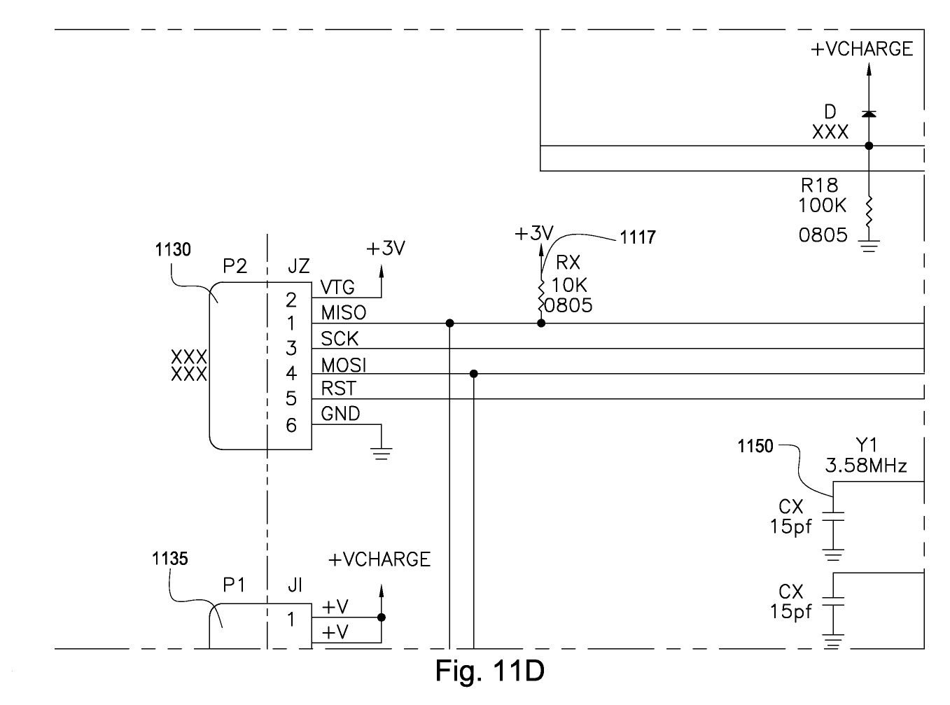

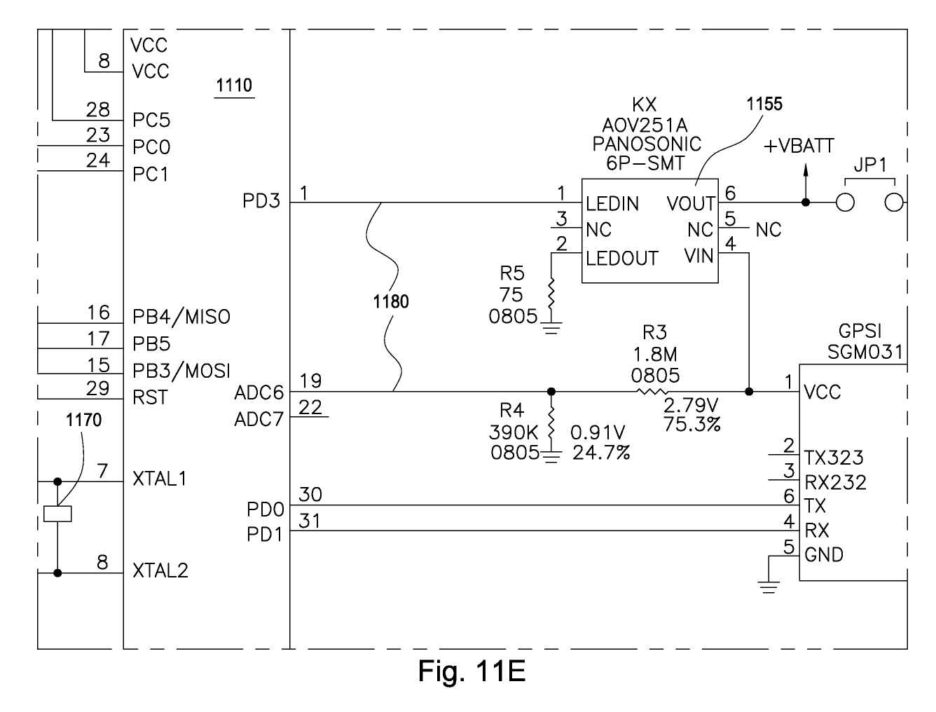

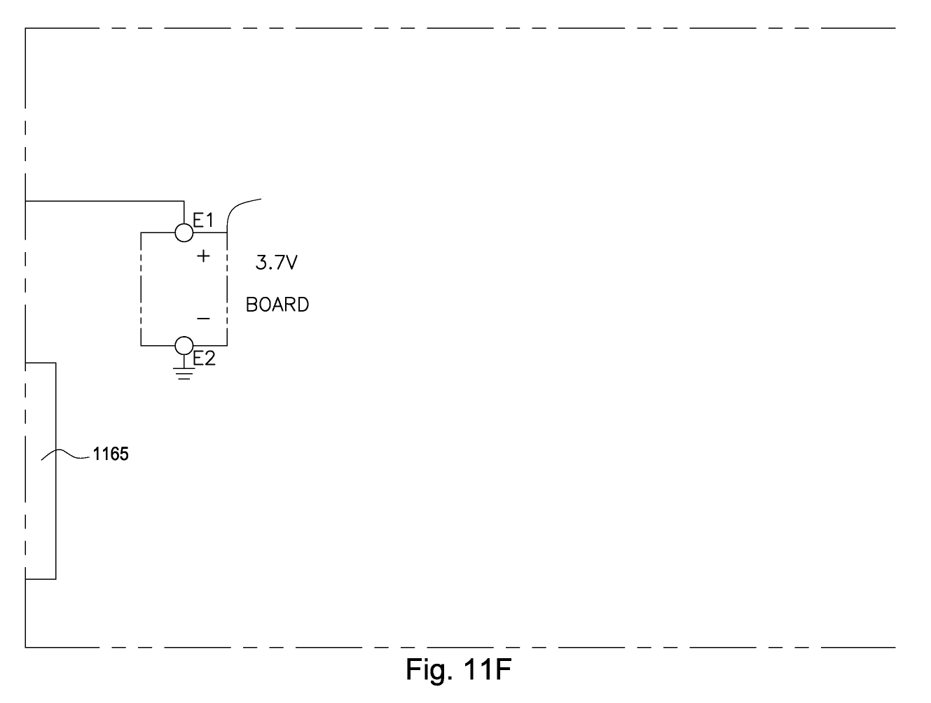

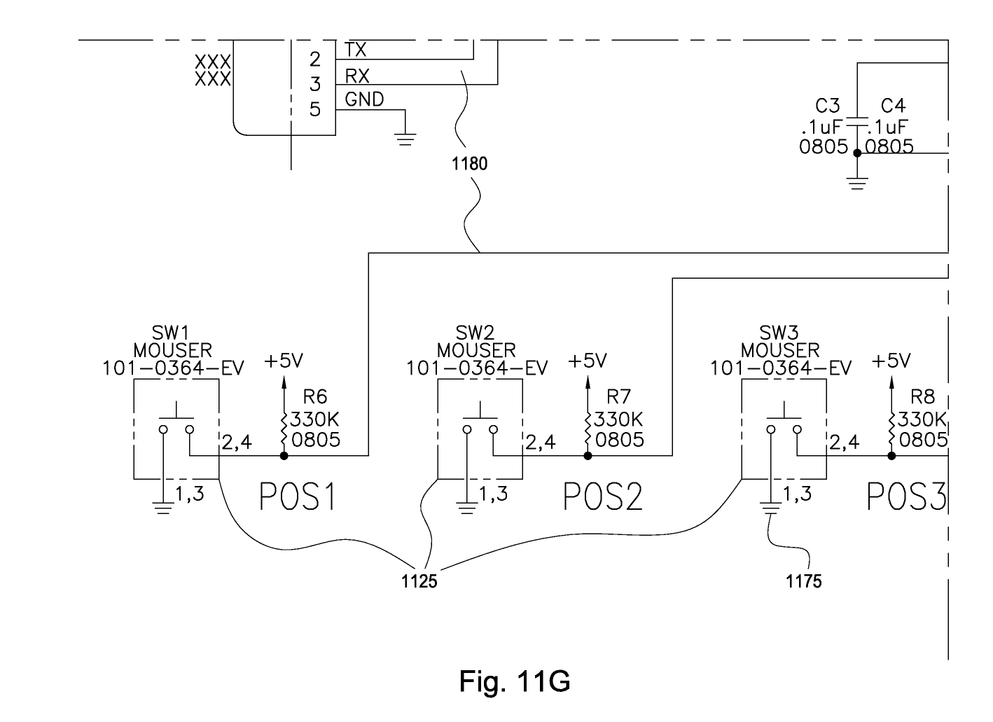

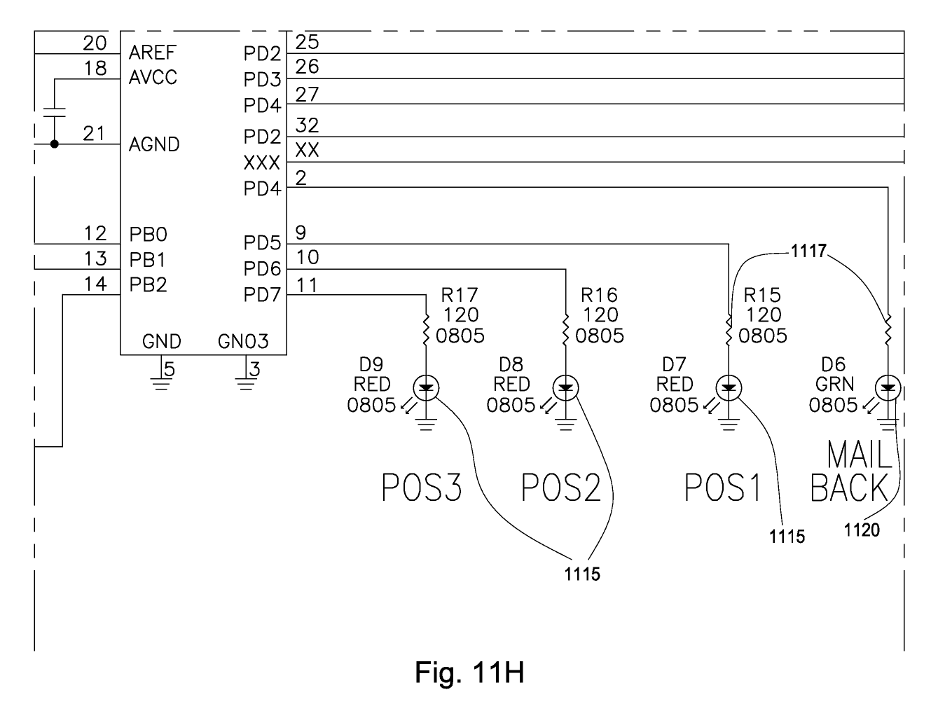

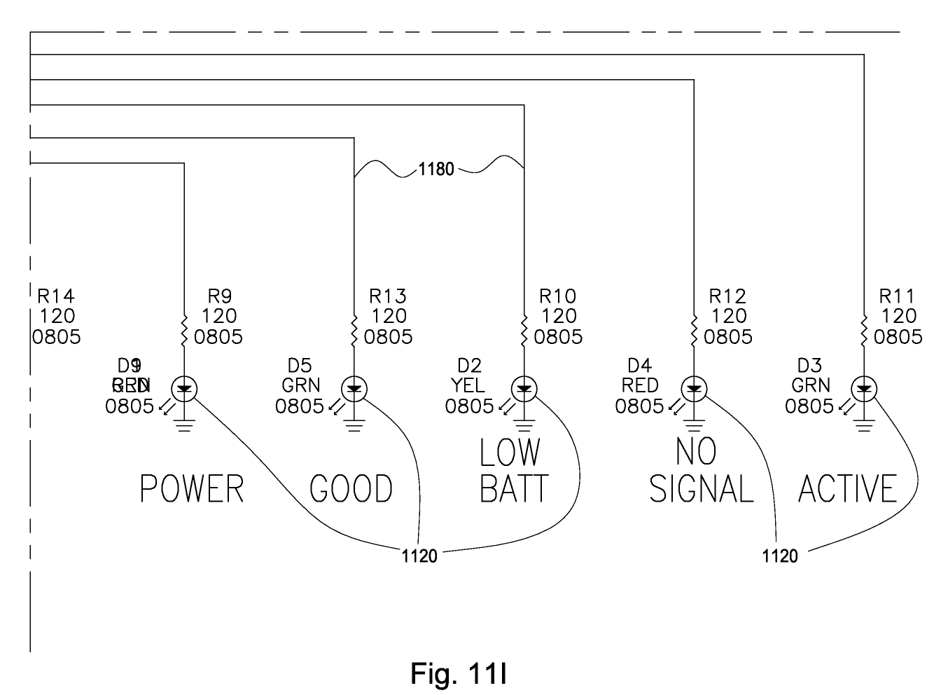

FIG. 11 illustrates a schematic diagram of a location registration card 410. As shown, one embodiment of the 3030A011 Location Registration Card's circuitry includes the following elements that are electrically coupled to a microprocessor IC 1110 and a common ground terminal 1175 by means of a plurality of transmission lines 1180 (e.g., wires): a plurality of first light emitting diodes (LEDs) 1115; a plurality of resistors 1117; a plurality of second light emitting diodes (LEDs) 1120; a plurality of first switches 1125; a USB connector IC 1130; a battery charger connector IC 1135; a plurality of battery charger ICs 1140; a second switch 1145 electrically coupled to a battery charger IC 1140; a plurality of capacitors 1150; a battery management IC 1155; a battery 1160 electrically coupled to the battery management IC 1155; a GPS/USB interface charger IC 1165; and a crystal oscillator 1170.

Accordingly, the microprocessor IC 1110 is configured to control operation of the card, and process and store user-inputted location information into the card's memory. The plurality of first LEDs 1115 are part of the activation module 450 and are configured to indicate a given number of available and/or unavailable location positions for a user to select from to input location information into the card 410. The plurality of second LEDs 1120 are part of the display module 470 and adapted to indicate to a card recipient that card is performing at least one of the following functions: attempting a GPS fix at a given location 110; indicating whether or not the attempted GPS fix at a given location 110 was successful (e.g., good GPS signal) or unsuccessful (e.g., no GPS signal); indicating when the battery 1160 is low on power and needs to be recharged; and prompting the card recipient to mail or otherwise return the card back to the card distributing entity; and indicting that the card is either activated or deactivated. The plurality of first switches 1125 (e.g., push button switches) are the activation module buttons that correspond to a number of location positions. The USB connector IC 1130 is adapted to receive a USB cable such that the card 410 may be coupled to the data collection module 720 (e.g., computer system or database) so that information stored in the card may be downloaded to and stored in the data collection module 720. The battery charger connector IC 1135 enables the card 410 to be recharged by a battery recharging device. The battery charger ICs 1140 enables the battery 1160 in the card to be rechargeable. The second switch 1145 (e.g., push button switch) is part of the control module 510 that enables the card to be activated and deactivated by a user.

Additionally, the battery management IC 1155 is adapted to monitor voltage levels of the battery 1160 and transmit a signal to the microprocessor 1110 when the battery voltage level drop below a predetermined threshold, wherein said signal is displayed as light from one of the LEDs 1120 warning a user that the card's battery power is low and needs to be recharged. The battery 1160 is configured to provide DC power to the card without assistance from an external power source. The GPS/USB interface charger IC 1165 is adapted to for the tracking module 440 to be coupled to the card, thereby enabling the card to have a GPS capability. The crystal oscillator 1170 is in electrical communication with the microprocessor 1110 and configured to control the speed for which the microprocessor IC 1110 processes location information that a card recipient inputs into the card by means of pressing the activation module buttons.

The present inventive apparatus, system, and method may also be employed by Nursing Homes/Elderly Care Providers to track elderly and sick persons living independently with children and other authorized representatives receiving notifications. Advantageously, the loved ones would have an idea of where to start looking when people fail to report in and/or go missing. For example, elderly and sick persons may be requested to report in whenever they return home as a safety precaution. Such an embodiment may be facilitated by providing a special docking station which automatically recharges the card and takes care of the return home report. The Elderly reporting system may not require a biometric reading since elderly and sick persons willing to carry the card are unlikely to falsify reports. For those at risk of wandering due to dementia it, the card(s) 410 may be equipped with active radio frequency (RF) technology for automatically downloading readings at common locations such, but not limited to, banks, bus stations, air port entrances etc., so that a person wandering due to dementia may trigger a response from their care givers before they wander too far. Some of this has been done via active RF tracking using GPS enabled phones by GPS-SAFE but this required an expensive cell phone and data plans and had limited battery life due to the nature of the involved technology. In contrast the simple card 410 may operate for weeks on a single battery charge, will recharge automatically from the sun, and does not require a wireless data plan.

Also, the present inventive apparatus, system, and method may be employed by manufacturers of major equipment. For example, a piece of major equipment may be permanently attached with a card 410. Then, when the equipment is serviced, a local reader may read the information from the card 410, which includes a periodic GPS reading, minimum/maximum temperatures, and possibly periodic vibration readings, thereby enabling major equipment vendors to limit warranty service risk by not covering units which have been out of the area or have been subject to temperature extremes. Inventory tracking and association of job related costs for hours of operation may also be improved. For example, the card 410 may calculate the hours of operation by sensing vibration and may store job site location by GPS location, thereby providing accurate per job accounting billing of major equipment. Furthermore, the card 410 may include a large solar cell or module 810 that allows more frequent readings and less user interface since the card may be mounted to inaccessible locations, such the top of a CAT cab. The card may also include hand free downloading and reading from at least fifteen feet. Uniquely, the telemetry gathered by the card 410 may be completely independent of other electronics of the equipment or vehicle, and times, locations and movement data, such as from semi trucking companies, which may assist an employee accused of violating mandatory rest periods.

Further, the present inventive apparatus, system, and method may be employed for registration of major disaster locations. For example, the use of a card 410 may provide locations where people living in an area affected by major disaster are after the disaster. Also, use of the card may help loved ones find each other, and develop demographics about population movement which can help coordinate delivery of emergency services. For instance, people in an area 110 likely to be hit by a major disaster may be issued these cards prior to a disaster occurring. The cards 410 may be inert until a disaster occurs. Then, after the disaster occurs, the card(s) 410 may be activated and take a reading. The cards may also be equipped so that readings may be transferred to any another card, wherein each card may store up several readings, such as thousand readings. In addition, when a person with a card 410 goes near a reader their set of readings may be uploaded, and if the reader is trusted, the existing set of readings may be erased, such as by intra net uplink. Accordingly, people may exchange readings with each other, including their location information, as well as upload readings and information, such as information to aggregate both their location and information, such as state of health, into a master database.

Advantageously, this present invention replaces the laborious, time consuming and delayed process of writing names down at the Red Cross service stations. The information may also be kept private because only the card ID may be stored with the location information and the card may be kept as confidential data, and even a person who collects a bunch of readings may not know who they belong too. Each card may also be modified to allow limited input of a state of health. Ultimately, the present invention may make the process of determining the state of loved ones an almost automatic process. Similarly, the card may be combined with a specialized server application which allows limited access to information to those who have a right to know, and which may be set up to automatically to provide notices, such as via email, when readings are received. Furthermore, duplicate readings may be automatically filtered out by the server software.

In addition, the present inventive apparatus, system, and method may be employed for proper registration, accountability, and inventory management of Department of Defense (DoD) assets vital to national security, particularly during training or combat operations. For example, a card distributing entity, such as a parent military organization, may distribute a plurality of cards 410 to their child military organization(s) deploying to austere location(s) 110 to conduct military training and/or combat operations. The instructions 430 on the cards 410 may instruct the child military organizations to press an activation module button(s) 450 at locations where assets, such as body armor, chemical weapon protective suits, guns, armored, vehicles, fighter/bomber/cargo aircraft, ammunition, top secret/secret/confidential documents and equipment, etc. are positioned. Further, the instructions 430 may instruct the child military organization(s) to mail the cards to their respective parent organization(s) for compilation in computer databases. One skilled in the art of conducting DoD training/combat operations would appreciate that DoD assets typically get transferred from one child military organization to another in cases where one organization provides a surplus of assets to another organization suffering from a shortage, or lack thereof. One skilled in the art would further understand that DoD assets typically get misplaced, or otherwise lost, due to the chaotic nature of training exercises and/or combat operations.

Advantageously, employment of the card(s) 410 may enable the parent military organization(s) to retrieve location information from their computer databases and match it against the responsible child military organization(s), thereby streamlining the process of conducting lost equipment investigations and facilitating the collection of funds needed to replace/manufacture the lost or misplaced assets. In such instances, the parent military organization(s) may hold their respective child military organization(s) accountable for proper management of thousands of dollars worth of DoD assets.

The present inventive apparatus, system, and method may also be employed for tracking rental and fleet equipment, such as rental vehicles and the like. For instance, the card(s) 410 may be adapted for self-activation to take equipment location readings, rather than waiting for a button push, and may take periodic readings, such as once per hour, and upload the readings to the rental facility upon return. The card(s) 410 may additionally be easy to adhesively affix to a surface, such as a windshield right behind the rear view mirror of a vehicle, and may not require any other integration with the vehicle. For larger equipment, a card or environmentally sealed unit may be affixed to the top of the vehicle, such as with glue, such that the unit may or may not be destroyed in the process of removal. For example, a small hand-held reader may exchange readings using IR or ultrasonic within a distance, such as within a two to five foot radius, or active RF technology may be used within a distance, such as a twenty five to fifty foot radius, to automatically download readings when equipment is returned. Beneficially, any use outside the approved area 110 may be tracked and billed at a higher rate, such as when state and country boundaries 180 are crossed.

Alternatively, the card(s) 410 may be used by companies and agencies providing vehicles and equipment for daily use by employees, such as mail trucks, which may not need real time tracking, but may need to know if the vehicle is being used outside of approved areas 110. In addition, companies who provide cars which are not supposed to be used for other personal uses may gain a fair knowledge of vehicle use during off hours. Advantageously, the card 410 may be close to the size of a credit card and less than one-half inch thick. As a result, the card may be affordable enough to equip vehicles in large volumes, while providing hands free downloading needed for large scale fleet management and fast and easy installation without requiring integration into the rest of the vehicle's electrical system.

Moreover, the present inventive apparatus, system, and method may be employed to register private location(s) 110. For example, rail roads and INS agents may record locations of problems, such as broken fences, contaminated water, salinity problems, areas needing service, etc. For example, one or more locations 110 may be initially recorded by a card 410. Then, these readings may be downloaded upon arrival at a home, an office, or another structure 170, as well as additional information recorded such as reason for recording that location 110. Further, the card may include a direction indicator along with a multiple digit display on the card 410, enabling the current location 110 to be displayed, many locations 110 to be recorded, and the reason for the recording to be selected from a pre-defined list while a user is in the field.

The additional features may be particularly useful for service people working for larger companies since it would eliminate the need for follow-up data entry upon return to a home or office. The same concept may also be used by outdoorsmen, or hikers, to record milestones during hikes, key fishing spots, etc. Advantageously, unlike other hand held GPS units, the card 410 is small, light and recharges by exposure to the sun, which enables the card to be readily available to record positions where a bulkier unit would not. In addition, the cards may be relatively inexpensive and may not contain a large screen, but may be small and tough. In one embodiment, the card may include a special docking adapter for recording location information, thereby enabling location information to be uploaded from the card to a computer.

Also, the present inventive apparatus, system, and method may be employed by State agencies, such as Animal Control Agencies, to register/license domestic animals 140, such as pets. The State agencies may distribute card(s) 410 to individuals owning pets, such as dogs and cats. The instructions 430 on the card may request the individuals to activate to the activation module button(s) 450, thereby enabling the card(s) 410 to collect location information pertaining to the pets, such as a number of pets, pet types/breeds, etc. In one embodiment, the instructions 430 may request the pet owners to manipulate a camera module 820 to capture pictures of pets and mail the card(s) containing location information/digital photographs of pets therein for addition into pet registration databases at the State agencies. Beneficially, employment of the card(s) 410 for pet registration purposes by State Agencies ensures that pet owners register and/or license their pets. Further, capturing pictures of the pets may assist pet owners and animal control agencies with locating and/or recovering lost or missing pets.

More, the apparatus, system, and method may be employed by State's Department of Public Safety (DPS), wherein DPS employees may distribute the card(s) 410 to its residents as part of a residential registration process. It is envisioned that the residents may input their location information (e.g., physical address, phone number) into the card and return the card back to the DPS. Advantageously, in cases where a resident make a 911 call during an emergency, the DPS may retrieve the resident's location from their databases; thereby facilitating a timely dispatch of emergency services personnel to the resident's home. A timely response by emergency services personnel may help save the resident's life or otherwise minimizing the chances of emergency situation from becoming a disaster.

Still more, the apparatus, system, and method may be employed at weigh stations operated by the State's Department of Transportation (DOT), wherein card recipients, such as commercial truck drivers may input information (e.g., truck weights, fuel logbooks, hours of service, weigh station location) into the card 410 and return the card to DOT employees at the weigh stations. This would significantly help the DOT track locations of its weigh stations; and ensure that the commercial truck drivers comply with Federal/State fuel tax laws and weight restriction requirements.

Further, the apparatus, system, and method may be employed by the U.S. Department of State (DOS) to effectively manage the passport application process. It is envisioned that the DOS may distribute the card(s) 410 to U.S. citizens applying for passports at the U.S. Post Offices for example. In turn, the passport applicants may input their information (birth certificate data, driver's license data, physical address, phone number) into the card and give the card back to the U.S. Postal Office Clerk. The U.S. Postal Worker Clerk may then mail the card to the DOS so that the DOS may download the passport applicant's information into their computer databases. Advantageously, this may virtually eliminate the excessive use of paper to complete the application process, thus reducing the cost of paper as well as speed up the process so that passport applicants may receive their passports sooner.

Still further, the apparatus, system, and method may be employed by College or University Housing Authorities during a process of registering students for college or university housing. It is envisioned that the said Housing Authority may distribute the card(s) 410 to its students desiring to reside in college or university housing. In turn, the prospective student residents may input their location information (e.g., student number, dormitory building and room number, and projected length of residency lease) into the card and return the card to said Housing Authority for insertion into their databases. Advantageously, using the apparatus, system, and method as a means to register college or university students for housing would help the Housing Authority effectively track housing availability, student payment of rent, housing maintenance activities, etc.

According to one embodiment, the apparatus, system, and method may be employed by a State/Municipal Building Division or the like to manage/track the issuance building permits to real property developers (e.g., engineers, architects, contractors, homeowner, etc.) desiring to build new property or make improvements to existing property. It is envisioned that said State/Municipal Building Division may distribute card(s) 410 to the property developers so that the property developers may input their information (e.g., property address/location, description of work, square footage data, construction plans, plumbing requirements, electrical wiring requirements, and energy requirements) into the card. In turn, the property developers may return the cards to the State/Municipal Building Division for inclusion into computer databases or the like. Advantageously, this would facilitate effective tracking of building permits issued to property developers; and inspection of developed property to ensure that property developers comply with State/Municipal imposed building construction codes and laws. Further, the building permit data may be submitted to the U.S. Census Bureau for inclusion into the Bureau's Statistical Database.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although FIG. 1 illustrates that the card 410 may be used to obtain location information pertaining to animals 140 at given location(s) 110, one skilled in the art would understand that the card may be employed to track the location information regarding other object(s) of interest according to various embodiments of the invention. Some other non-limiting uses of the card 410 may include: tracking and reporting on the location of a company's inventory items and/or assets; recording and/or registering the location of new roadway(s) 130, abandoned roadways 150, new highways and/or major streets 160, structures 170, political boundaries 180 for use by civil engineers, map surveyors and/or developers, etc.; forest service tracking and asset management; Bureau of Land Management tracking and asset management; tracking and documenting the location 110 of a wide variety of communication systems and/or supplies such as radio systems, mines, guns, grenade launchers, chemical weapon protective suits/masks, protective armor, armored vehicles, etc. owned and/or controlled by Department of Defense and/or Military Organizations deployed at austere locations 110 during training and/or combat operations; recording location of and registering retail company's inventory items distributed at various subordinate retail companies or subsidiaries; etc; pinpointing location information of real property requiring to be registered and/or recorded in a municipal, county, state, etc. database; tracking location of aircraft owned by private and commercial companies in the airlines industry; etc., and other purposes of locating and registering object(s) of interest.

Also, although the figures illustrate a location registration card 410 being employed to track the location 110 of, and location information pertaining to animals 140 and other objects, it is envisioned that a plurality of other hand-held electronic devices with tracking module(s) 440 coupled thereto may be used to perform the functionality of the present invention. Some non-limiting examples of such hand-held electronic devices include: personal digital assistants (PDAs), cellular telephony, palm pilots, wrist watches, etc.

It is envisioned that the card distributing entity may comprise retail stores, government agencies, schools, churches, military organizations, and any other business organization that possesses animals 140, assets, animals, inventory, and other resources that may be dispersed or otherwise deployed at a plurality of geographically separated locations 110 controlled, rented, or owned by the entities.

It also envisioned that the mailing information 420, instructions 430, activation module 450, power module 485, control module 510, etc. may be disposed anywhere on the card 410 wherein its functionality can be accomplished according to alternative embodiments.

More, it is further envisioned that mailing information 420 may include physical addresses, street names, postal codes, etc. from foreign countries; and/or military postal zip code (APO/FPO) locator information of military units/personnel deployed to austere locations 110 in a plurality of domestic and foreign countries in the world.

Further, it is still further envisioned that the number of activation module buttons 450 disposed on the card 410 may vary according to various embodiments. For example, there may be two, three, six, eight, nine, or any other number of buttons 450 depending on the variation of card(s) manufactured.

It is expected that there could be numerous variations of the design of this invention. For example, the map 100; location 110; animals 140; card 410; mailing information 420; instructions 430; tracking module 440; activation module 450; information reception module 460; display module 470; transmission module 475; power module 485; information reset module 490; control module 510; card labeling module 710; data collection module 720; solar module 810; camera module 820; securing mechanisms 830, 1010; magnetic reader strip 910; and/or port 1020 may vary in shape, size, length, width, design, brand, color, thickness, etc. according to different embodiments of the invention.

It is also expected that the card 410 may be manufactured to have any number of activation module buttons 450 and/or be employed to store any number of locations, other than up to five locations.

Finally, it is envisioned that the components of the device may be constructed of a variety of materials, such as, but not limited to polymer, plastic, composite material, ferromagnetic material, silicon, glass, aluminum, cooper, metal alloys, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A method for tracking animals, comprising the following steps:
providing a card, including a tracking module;
associating the card with a recipient;
mailing the card to the recipient;
enabling the recipient to activate the tracking module;
acquiring location information upon activation of the tracking module; and
storing the location information.

2. The method of claim 1, further comprising the step of enabling the recipient to mail the card.

3. The method of claim 2, wherein the step of enabling the recipient to mail the card includes enabling the recipient to return the card.

4. The method of claim 2, wherein the step of enabling the recipient to mail the card includes enabling the recipient to forward the card.

5. A tracking device for tracking animals, comprising:
a card, including:
mailing information, disposed on the card; and
a tracking module, removably coupled to the card, having:
an activation module; and
a reception module.

6. The tracking device of claim 5, wherein the card further comprises a transmission module, in communication with the tracking module, configured to transmit location information from the tracking module.

7. The tracking device of claim 5, wherein the card further comprises an information storing module, in communication with the tracking module, configured to store location information.

8. The tracking device of claim 5, wherein the card further comprises instructions.

9. The tracking device of clam 5, wherein the tracking module further comprises a display module.

10. The tracking device of claim 7, wherein the card further comprises a information reset module, in communication with the information storing module, configured to reset location information.

11. A system for tracking animals, comprising:
a card labeling module, configured to label a card with mailing information;
a card, in communication with the card labeling module, including mailing information;
a tracking module, removably coupled to the card, having:
an activation module; and
an information reception module; and
a data collection module, in communication with the tracking module, configured to collect location information from the tracking module.

12. The system for tracking animals of claim 11, further comprising a transmission module, in communication with the tracking module and in communication with the data collection module, configured to transmit location information from the tracking module to the data collection module.

13. The system for tracking animals of claim 11, further comprising an information storing module, in communication with the tracking module, configured to store location information.

14. The tracking device of claim 11, wherein the card comprises instructions.

15. The tracking device of clam 11, wherein the tracking module further comprises a display module.

16. The tracking device of claim 13, further comprising an information reset module, in communication with the information storing module, configured to reset location information.
